(19) United States
(12) Patent Application Publication
(10) Pub. No.: US 2023/0401550 A1
(43) Pub. Date: Dec. 14, 2023

(54) Fee Distribution System and Method

(71) Applicant: Adam Mikolajczuk, Los Angeles, CA (US)

(72) Inventor: Adam Mikolajczuk, Los Angeles, CA (US)

(21) Appl. No.: 18/450,395

(22) Filed: Aug. 15, 2023

Related U.S. Application Data
(63) Continuation-in-part of application No. 18/112,276, filed on Feb. 21, 2023.
(60) Provisional application No. 63/312,009, filed on Feb. 19, 2022.
(60) Provisional application No. 63/398,730, filed on Aug. 17, 2022.
(60) Provisional application No. 63/459,130, filed on Apr. 13, 2023.

(51) Int. Cl. G06Q 20/12; G06T 11/00; G06T 1/00; H04L 9/32

(52) U.S. Cl. CPC G06Q 20/123; G06T 11/00; G06T 1/0021; H04L 9/32

(57) ABSTRACT

A system to distribute fees to a distribution recipient for the use of the distribution recipient's digital media file by a generative artificial intelligence. The system may be configured to receive a digital media file, the digital media file including at least one of the likeness of a user associated with the distribution recipient or the likeness of a property associated with the distribution recipient, receive a share structure for the distribution of a usage fee, and distribute a share of the usage fee to the distribution recipient when a usage event is detected, where the share is set by the share structure.

### CROSS-REFERENCE TO RELATED APPLICATIONS

This application is a Continuation-in-part of, and claims priority to, U.S. Non-provisional patent application Ser. No. 18/112,276, filed on Feb. 21, 2023, which claims priority to U.S. provisional patent application No. 63/312,009, filed Feb. 19, 2022, the contents of which are incorporated by reference in their entirety. This application further claims priority to U.S. provisional patent application No. 63/398,730, filed on Aug. 8, 2022, and U.S. provisional patent application No. 63/459,130, filed on Apr. 13, 2023, the contents of which are incorporated by reference in their entirety.

### BACKGROUND

### Field of the Invention

The present invention relates generally to fee distribution systems, and, in particular, to a system to distribute fees when a digital media file including a likeness of the distribution recipient or their property is used by a generative artificial intelligence.

### Scope of the Prior Art

The entertainment and creative industries are currently facing significant challenges due to the proliferation of media generated by a generative artificial intelligence. Such generative artificial intelligence models are trained on existing content, often neglecting to provide proper royalties or compensation to the original content creators, their representatives, or content owners. The present invention addresses this pressing issue by enabling the aforementioned stakeholders to receive financial rewards whenever their content is used by a generative artificial intelligence. This invention thus seeks to establish a fair and equitable framework for content usage and remuneration in the age of artificial intelligence generated entertainment.

### SUMMARY

The present disclosure satisfies the foregoing needs by providing, inter alia, a system to distribute fees addressing each of the foregoing desirable traits as well as its methods of use.

One aspect of the present invention is directed at a system to distribute fees to a distribution recipient for the use of the distribution recipient's digital media file by a generative artificial intelligence, the system comprising: memory storing executable instructions; a processing device executing the instructions, wherein the instructions cause the processing device to: receive a digital media file, the digital media file including at least one of the likeness of a user associated with the distribution recipient or the likeness of a property associated with the distribution recipient; receive a share structure for the distribution of a usage fee; and distribute a share of the usage fee to the distribution recipient when a usage event is detected, where the share is set by the share structure.

Usage events include: the approval of a third-party request to use the digital media file for training a generative artificial intelligence; the approval of a third-party request to use the digital media file in the creation of media by the generative artificial intelligence; a third-party generation of media by the generative artificial intelligence, wherein the digital media file is used in the generation of the media by the generative artificial intelligence; a third-party publication of the media, wherein the digital media file is used in the generation of the media by the generative artificial intelligence; and a third-party monetization of the media, wherein the digital media file is used in the generation of the media by the generative artificial intelligence.

Another aspect of the present invention is directed at A computer-implemented method for distributing fees to a distribution recipient for the use of the distribution recipient's digital media file by a generative artificial intelligence, the method comprising: receiving a digital media file, the digital media file including at least one of the likeness of a user associated with the distribution recipient or the likeness of a property associated with the distribution recipient; receiving a share structure for the distribution of a usage fee; and distributing a share of the usage fee to the distribution recipient when a usage event is detected, wherein the share is set by the share structure.

### BRIEF DESCRIPTION OF THE DRAWINGS

The foregoing summary, as well as the following detailed description of preferred variations of the invention, will be better understood when read in conjunction with the appended drawings. For the purpose of illustrating the invention, there is shown in the drawings variations that are presently preferred. It should be understood, however, that the invention is not limited to the precise arrangements shown. In the drawings, where:

FIG. 1 a block diagram showing example physical components of a fee distribution system with which aspects of the present disclosure may be practiced.

FIG. 2 is a block diagram showing an example network incorporating the fee distribution system, according to an embodiment.

FIG. 3 is a block diagram showing steps of a fee distribution method, according to an embodiment.

FIG. 4 is a block diagram showing example physical components of a watermarking system, according to an embodiment.

FIG. 5 is a block diagram showing steps of a watermarking method, according to an embodiment.

FIG. 6 is a block diagram showing example physical components of an experience recording system, according to an embodiment.

### DETAILED DESCRIPTION

Implementations of the present technology will now be described in detail with reference to the drawings, which are provided as illustrative examples so as to enable those skilled in the art to practice the technology. Notably, the figures and examples below are not meant to limit the scope of the present disclosure to any single implementation or implementations. Wherever convenient, the same reference numbers will be used throughout the drawings to refer to same or like parts.

Moreover, while variations described herein are primarily discussed in the context of a system to distribute fees for the use of digital media files by a generative artificial intelligence, it will be recognized by those of ordinary skill that the present disclosure is not so limited. In fact, the principles of the present disclosure described herein may be readily applied to fee distribution systems in general.

In the present specification, an implementation showing a singular component should not be considered limiting; rather, the disclosure is intended to encompass other implementations including a plurality of the same component, and vice-versa, unless explicitly stated otherwise herein. Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

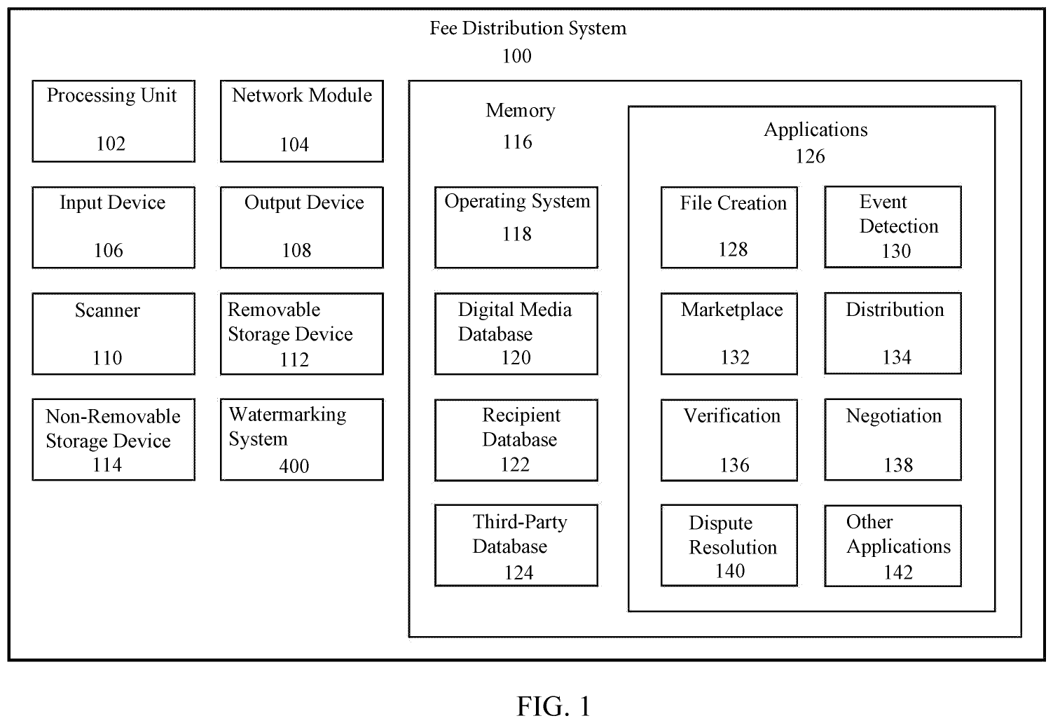

FIG. 1 is a block diagram showing example physical components (e.g. hardware) of a fee distribution system 100. In some embodiments, the fee distribution system 100 is integrated into, or otherwise part of, the watermarking system 400. Alternatively, the fee distribution system 100 is a standalone system.

In its basic configuration, the fee distribution system 100 may include at least one processing unit 102 and memory 116.

The processing unit 102 executes commands to perform the functions specified in flowcharts and/or block diagram blocks throughout this disclosure. It should be appreciated that processing may be implemented either locally via the processing unit 102 or remotely via various forms of wireless or wired networking technologies or a combination of both.

The term computer readable media as used herein may include computer storage media. Computer storage media may include volatile and nonvolatile, removable and non-removable media implemented in any method or technology for storage of information, such as computer readable instructions, data structures, or program modules. The memory 116, the removable storage device 112, and the non-removable storage device 114 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the fee distribution system 100. In some embodiments, such computer storage media may be part of the fee distribution system 100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

Memory 116 may include various types of short and long-term memory as is known in the art. Memory 116 may be loaded with various applications 126 in the form of as computer readable program instructions. These computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Applications 126 may include a file creation application 128, an event detection application 130, a marketplace application 132, a fee distribution application 134, a verification application 136, a negotiation application 138, and a dispute resolution application 140, as will be further discussed. Accordingly, memory 116 includes all necessary applications 126 per each embodiment.

The file creation application 128 is configured to generate a digital media file based on a scan of a user associated with a distribution recipient or a property associated with a distribution recipient. A distribution recipient may be a person or an entity. Multiple distribution recipients may be associated with a single digital media file. Furthermore, multiple digital media files may be associated with a single distribution recipient. The digital media file may be saved in digital media files 120.

The event detection application 130 is configured to detect usage events. Usage events may include the approval of a third-party request to use the digital media file for training a generative artificial intelligence or the approval of a third-party request to use the digital media file in the creation of media by a generative artificial intelligence. To detect these usage events, the event detection application 130 may continuously or periodically check for the approval of third-party requests received by the system 100.

Usage events may further include the third-party generation of media by a generative artificial intelligence, where the digital media file is used in the generation of the media by the generative artificial intelligence. To detect this usage event, the event detection application 130 may continuously or periodically scan the digital media database 120 and publicly available media databases to determine if any of the digital media files have been used in the third-party generation of media by a generative artificial intelligence. This determination is made using digital media comparison algorithms, such as scale-invariant feature transform algorithms, to compare the digital media file to other digital media files in the digital media database 120 and publicly available media databases.

Usage events may further include the third-party dissemination of media, wherein the digital media file is used in the generation of the media by a generative artificial intelligence. Dissemination of the media includes, but is not limited to, sharing, exporting, publicizing, or otherwise transferring the media to another party. To detect this usage event, the event detection application 130 may continuously or periodically scan the digital media database 120 and publicly available media databases for disseminated media. It then determines if any of the digital media files have been used in the generation of the disseminated media, where the disseminated media was generated by a generative artificial intelligence. This determination is made using digital media comparison algorithms, such as scale-invariant feature transform algorithms, to compare the digital media file to disseminated media in the digital media database 120 and publicly available media databases.

Usage events may further include the third-party monetization of media, wherein the digital media file is used in the generation of the media by a generative artificial intelligence. Monetization of the media includes, but is not limited to, selling, leasing, or otherwise generating revenue or profit from the media. To detect this usage event, the event detection application 130 may continuously or periodically scan the digital media database 120 and publicly available media databases for monetized media. It then determines if any of the digital media files have been used in the generation of the monetized media, where the monetized media was generated by a generative artificial intelligence. This determination is made using digital media comparison algorithms, such as scale-invariant feature transform algorithms, to compare the digital media file to monetized media in the digital media database 120 and publicly available media databases.

The marketplace application 132 is configured to provide a digital marketplace for the sale, lease, or other monetization of digital media files. Digital media files can be added to the digital marketplace by the associated distribution recipients. The right to use the digital media files with a generative artificial intelligence can be purchased by third parties.

In an embodiment, the usage fee depends, at least in part, on the format of the digital media file. For example, the digital media file is a video with sound. The usage fee for the video with sound is $10 while the usage fee for the sound alone is $5.

In another embodiment, the usage fee depends, at least in part, on the extent of the use of the digital media file. For example, the digital media file is a minute-long video with sound. The usage fee for all sixty seconds is $10 while the usage fee for thirty seconds is $5.

In another embodiment, the usage fee depends, at least in part, on the extent of the use of the digital media file relative to the extent of the use of other digital media. For example, the digital media file is a 50 MB video with sound. The digital media file was used in the generation of media by a generative artificial intelligence. Namely, the generative artificial intelligence used the 50 MB digital media file and 950 MB of other digital media in the generation process. Thus, for any third-party monetization of the media, the usage fee is 5% of the monetization.

In another embodiment, the usage fee depends, at least in part, on the final sale price, profit, or other revenue generated from a third-party monetization of the media, where the digital media file is used in the generation of the media by a generative artificial intelligence. For example, the digital media file is a video with sound. To use the digital media in the generation of the media by a generative artificial intelligence, a third party agrees to a usage fee of 5% of the final price, profit, or other revenue generated from the monetization of the media.

It should be understood that usage fees may depend, at least in part, on each of the aforementioned factors or a combination thereof.

In an embodiment, the usage fee is preset by the distribution recipients before the digital media files are presented on the digital marketplace.

In another embodiment, the usage fee is determined through negotiations between the distribution recipients and a third-party. The start of such negotiations may be conditioned on the detection of a usage event.

The fee distribution application 134 is configured to distribute fees to distribution recipients. The distributed fees are based on a share of the usage fee. The share for each distribution recipient is set by the share structure. The fees may be distributed by crediting the devices of the distribution recipients with the corresponding share of the usage fee. Fee distribution may be conditioned on the detection of a usage event.

The verification application 136 is configured to verify the contents of the digital media file. The verification process is described in U.S. patent application Ser. No. 18/112,276.

The verification application 136 is further configured to determine if a digital media file includes the likeness of a user not associated with the distribution recipient or the likeness of a property not associated with the distribution recipient. To make this determination, the verification application 136 may continuously or periodically use digital media comparison algorithms, such as scale-invariant feature transform algorithms, to compare the digital media file to other media in the digital media database 120 and publicly available media databases.

If a digital media file is determined to contain a likeness that does not belong to the distribution recipient, the verification application 136 can suspend account privileges for that distribution recipient or take other appropriate actions. Alternatively, if a digital media file is determined to be too similar to a likeness that does not belong to the distribution recipient, the verification application 136 can initiate a dispute resolution procedure for that distribution recipient or take other appropriate actions. Said functionality prevents users from monetizing the likeness of another person or his or her property.

In some embodiments, if a digital media file is determined to contain a likeness that does not belong to the distribution recipient, the verification application can automatically transfer the digital media file and associated rights to the distribution recipient associated with that likeness.

The negotiation application 138 is configured to provide negotiation functionality to facilitate negotiations between distribution recipients and third parties.

The dispute resolution application 140 is configured to provide a dispute resolution functionality to facilitate dispute resolutions.

Other applications 142 may provide additional functionality as required per each embodiment.

Memory 116 may further include an operating system 118, a digital media database 120, a distribution recipient database 122, and a third-party database 124 as will be further discussed. In certain embodiments, memory 112 may be implemented locally, whereas in other embodiments, memory 112 may be implemented remotely.

The operating system 114 is suitable for controlling the operation of the fee distribution system 100.

The digital media database 120 is configured to store digital media files in various digital media formats including, but not limited to, expressive recordings, audio recordings, images, and videos. In some embodiments, each digital media file includes embedded metadata that identifies the distribution recipient.

Expressive recordings are captured in expressive recording session, either independently or with an acting coach present. These sessions capture a broad spectrum of emotions, which are then labeled and categorized accordingly. Each recording may include detailed annotations, such as the emotions displayed, spoken lines, vocal tones, and more. The expressive recordings may be recorded in 360 degrees, providing a multitude of angles for each expression, line, and emotion. This serves to enhance the accuracy and depth of AI-generated content by leveraging these detailed recordings. Expressive recording sessions can include performing songs, doing stunts, and performing various actions and body movements.

The digital media database 120 is further configured to store a fee list containing usage fees for each digital media file, the shares set by the share structure for each digital media file, and a list of distribution recipients associated with each digital media file.

The distribution recipient database 122 is configured to store account data for distribution recipients. In some embodiments, account data may include a list of digital media files associated with each distribution recipient and a transaction history for each distribution recipient.

In some embodiments, the fee distribution system 100 enables distribution recipients to set permissions that require the distribution recipient's approval before the digital media file is used. These permissions can be tailored to different levels of content usage. For example, an actor may allow his or her likeness or product to be used for non-commercial viewing without their explicit approval. However, if their likeness or product is to be used in a revenue-generating movie or TV show, they might require the opportunity to approve its use.

The third party database 124 is configured to store account data for third parties. In some embodiments, account data may include a list of purchased or leased digital media files associated with each third party and a transaction history for each third party.

The fee distribution system may further comprise a network module 104, an input device 106, an output device 108, a scanner 110 as will be further discussed.

The network module 104 is configured to enable network connectivity among the fee distribution system 100, the electronic devices of distribution recipients, and the electronic devices of third parties. Network connectivity may be achieved through the use of common telecommunication infrastructure such as routers, switches, and gateways. Alternatively, network members may communicate according to conventional wireless communication standards including, but not limited to, Bluetooth.

The input device 106 is configured to enable interaction with the fee distribution system 100. Preferably, the input device 106 is a touchscreen or keypad. Alternatively, the input device 106 may be a smart phone or other external electronic devices in communication with the fee distribution system 100. Yet alternatively, the input device 106 may be a microphone for speech capture, a camera for visual text or motion capture, a keyboard, buttons, or any other device or method of receiving instructions.

The output device 108 is configured to enable interact with a distribution recipient or other third party users. Preferably, the output device 108 may be a display screen in any of the various forms associated with smart devices. Alternatively, the output device 108 may be a speaker, acoustic generator, or any other device or method of transmitting updates or data.

The scanner 110 is configured to capture a likeness of a user associated with the distribution recipient or a property associated with the distribution recipient. The likeness of the user may include his or her appearance, voice, character, personality, as well as any other defining characteristics while the likeness of the property may include its appearance, sounds, as well as any other defining characteristics.

In some embodiments, the scanner is a 3D scanner configured to capture the 3D appearance of the user or the property.

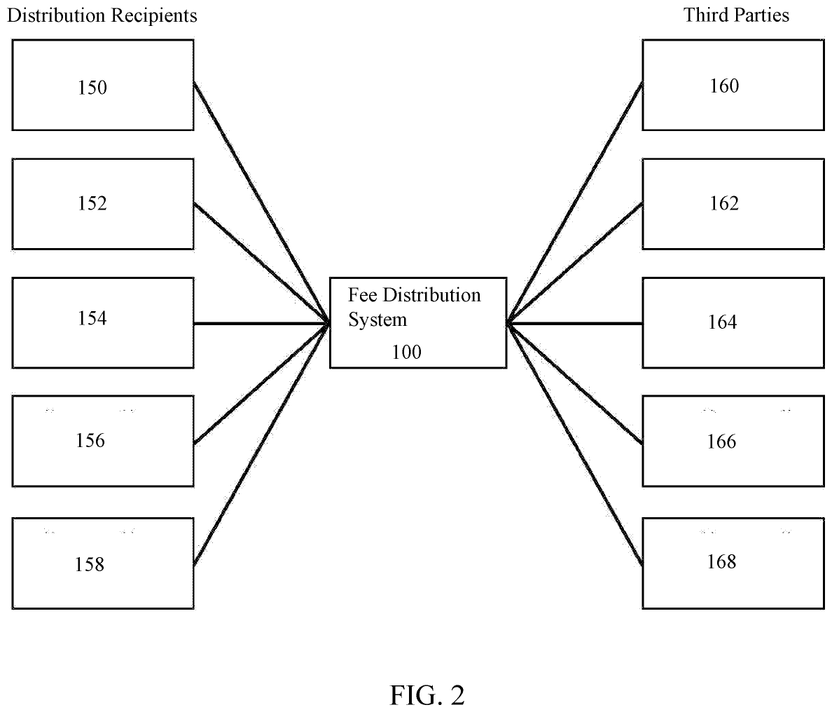

FIG. 2 is a block diagram showing an example network incorporating the fee distribution system, according to an embodiment.

The fee distribution system 100 is in communication with a plurality of distribution recipient electronic devices 150, 152, 154, 156, 158 and a plurality of third-party electronic devices 160, 162, 164, 166, 168. The network enables remote access to the fee distribution system 100 and its functionality.

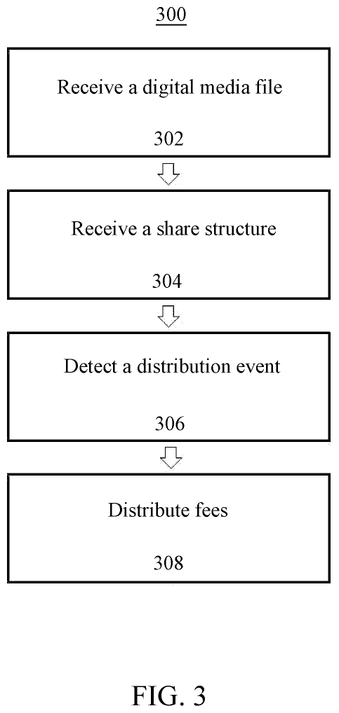

FIG. 3 is a block diagram showing steps of a fee distribution method 300, according to an embodiment.

The method may start at block 302 in which the fee distribution system 100 receives the digital media file, the digital media file including the likeness of a user associated with the distribution recipient or the likeness of a property associated with the distribution recipient. The digital media file may be received when the distribution recipient uploads the digital media file.

The method proceeds to block 304 in which the fee distribution system 100 receives the share structure. The share structure may be received when the distribution recipients upload a share structure.

The method proceeds to block 306 in which the fee distribution system 100 detects a usage event. The usage event may be the approval third-party request to use the digital media file.

The method proceeds to block 308 in which the fee distribution system 100 distributes fees to the distribution recipients. The fees may be distributed by crediting the accounts of the distribution recipients.

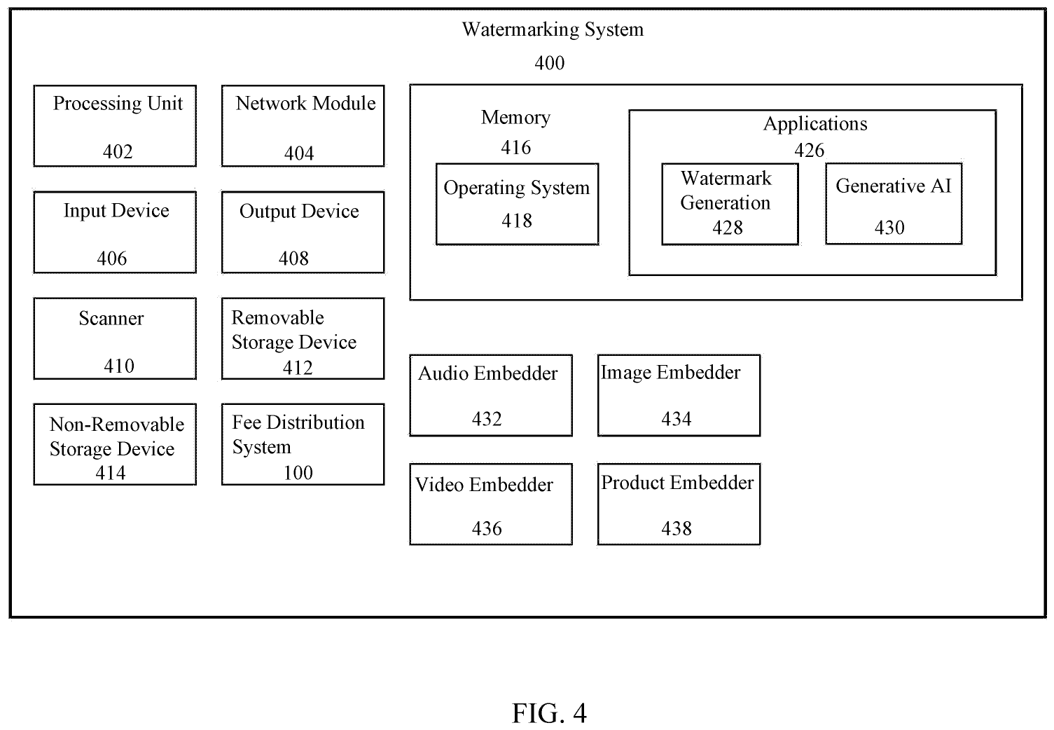

FIG. 4 is a block diagram showing example physical components of a watermarking system 400 configured to watermark media or products produced by a generative artificial intelligence. In some embodiments, the watermarking system 400 is integrated into, or otherwise part of, the fee distribution system 100. Alternatively, the watermarking system 400 is a standalone system.

Processing unit 402, network module 404, input device 406, output device 408, scanner 410, removable storage device 412, and non-removable storage device 414 may function similarly to processing unit 102, network module 104, input device 106, output device 108, scanner 110, removable storage device 112, and non-removable storage device 114 respectively.

Applications 426 may include a watermark embedder 428 and a generative artificial intelligence 430, as will be further discussed. Accordingly, memory 416 includes all necessary applications 426 per each embodiment.

The watermark embedder 428 is configured to embed a watermark within media or a product produced by a generative artificial intelligence. In some embodiments, the watermark, when extracted, identifies the generative artificial intelligence origins of the media or product, identifies which digital media files were used in the generation of the media or product by the generative artificial intelligence, identifies which digital media files were used in the training of the generative artificial intelligence that generated the media or product, and the like. In some embodiments, the watermark, when extracted, identifies the fee list containing usage fees for each digital media file used, the shares set by the share structure for each digital media file used, a list of distribution recipients associated with each digital media file used, and the like. In other embodiments, the watermark, when extracted, identifies the transaction history of the media.

Alternatively, the watermark, when extracted, instructs a user how to reach a database or webpage containing the aforementioned identifying information. For example, the extracted watermark is a uniform resource locater (URL) to a website containing a list of digital media files used in the generation of the media by the generative artificial intelligence as well as the usage fees, shares, and distribution recipients associated with each digital media file.

In embodiments where the media or product is a digital media or product, the watermark embedder 428 embeds a corresponding digital watermark within the digital media or product.

If the media is a digital audio file, the watermark embedder 428 embeds a digital audio watermark into the digital audio file (e.g., using spread spectrum audio watermarking, echo hiding, support vector regression, patchwork, other well-known audio watermarking techniques, or a combination thereof). In some embodiments, the embedded digital audio watermark is outside of the average hearing range, rendering it imperceivable. Alternatively, fragments of the embedded digital audio watermark are arranged within the digital audio file in an imperceivable rhythm or pattern.

If the media is a digital image file, the watermark embedder 428 embeds a digital image watermark into the digital image file (e.g., using least significant bit modification, intermediate significant bit modification, patchwork, discrete cosine transform, discrete fourier transform, hybrid spatial and transform-domain algorithms, other well-known image watermarking techniques, or a combination thereof). In some embodiments, fragments of the embedded digital image watermark are arranged throughout the digital image file in a pattern imperceivable to the human eye.

If the media is a digital video file, the watermark embedder 428 embeds a digital video watermark into the digital video file (e.g., using least significant bit modification, intermediate significant bit modification, patchwork, discrete cosine transform, discrete fourier transform, hybrid spatial and transform-domain algorithms, other well-known video watermarking techniques, or a combination thereof). In some embodiments, fragments of the embedded digital video watermark are arranged across the digital video file in an imperceivable pattern.

The functionality of the watermark embedder 428 is not limited to digital audio, image, and video files. Rather, the watermark embedder 428 can embed watermarks into any digital media file, including, but not limited to, 3D CAD files, augmented reality associated files, and virtual reality associated files.

The functionality of the watermark embedder 428 is not limited to the aforementioned digital watermarking techniques. Rather, the embedding tools can be used to manipulate the digital media or products in any way that creates an extractable watermark.

For example, the digital watermark can be the manipulation of text variables in a digital text file such that a visual examination of the individual characters within the digital text file can be used to extract identifying information hidden in the watermark (e.g., identifying information is encoded in morse code through alternating use of a serif font and sans-serif font for the characters).

In embodiments where the media or product is a physical media or product, the watermark embedder 428, in conjunction with an embedding tool (e.g., the audio embedder tool 432, image embedder tool 434, video embedder tool 436, or product embedder tool 438), embeds a corresponding physical watermark onto the physical media or product.

If the media is a physical audio product (e.g., a record or tape), the watermark embedder 428, in conjunction with the audio embedder tool 432, embeds a physical audio watermark into the physical audio product (e.g., a physical audio watermark is engraved onto the surface of a record).

If the media is a physical image product (e.g., a photograph or print), the watermark embedder 428, in conjunction with the image embedder tool 434, embeds a physical image watermark into the physical image product (e.g., a physical image watermark is printed onto the surface of a photograph in ultraviolet-reflecting ink).

If the media is a physical video product (e.g., a roll of film), the watermark embedder 428, in conjunction with the video embedder tool 436, embeds a physical image watermark into the physical video product (e.g., a physical video watermark is printed onto the surface of individual frames of the roll of film in ultraviolet-reflecting ink).

If the media is a physical product (e.g., a beverage or a circuit board), the watermark embedder 428, in conjunction with the product embedder tool 438, embeds a physical product watermark into the product. (e.g., a physical product watermark is molded into the side of a beverage can).

The functionality of the audio embedder tool 432, image embedder tool 434, video embedder tool 436, and product embedder tool 438, is not limited to the aforementioned physical watermarking techniques. Rather, the embedding tools can be used to manipulate the physical media or products in any way that creates an extractable watermark.

For example, the physical watermark can be the incorporation of specific materials, or a pattern thereof, such that sampling the product in a spectroscope can be used to extract identifying information hidden in the watermark.

Alternatively, the physical watermark can be the incorporation or application of specific chemicals, or a pattern thereof, in the product such that smelling or tasting the product can be used to extract identifying information hidden in the watermark.

Yet alternatively, the physical watermark can be the incorporation of specific surface textures, or a pattern thereof, such that tactile examination of the product can be used to extract identifying information hidden in the watermark.

Yet alternatively, the physical watermark can be the incorporation of specific particulates or fibers, or a pattern thereof, in the product such that visual examination of the product under a microscope can be used to extract identifying information hidden in the watermark.

The watermark embedder 428 may be further configured to transmit watermarking instructions to an electronic device associated with the media, where the watermarking instructions, when executed by the electronic device, cause the electronic device to embed the media with a digital watermark.

In some embodiments, a third party, in order to access a digital media file, may be required to agree to watermark any media generated by a generative artificial intelligence that uses the digital media file. For example, an electronic device receives a digital media file from the fee distribution system 100. The digital media file is used in the generation of new media by a generative artificial intelligence. The electronic device receives watermarking instructions from the system 100 and executes them, embedding a watermark in the new media. Alternatively, the electronic device transmits the new media to the watermarking system 400 after it is generated. The watermarking system 400 then embeds a watermark in the new media and transmits it back to the electronic device.

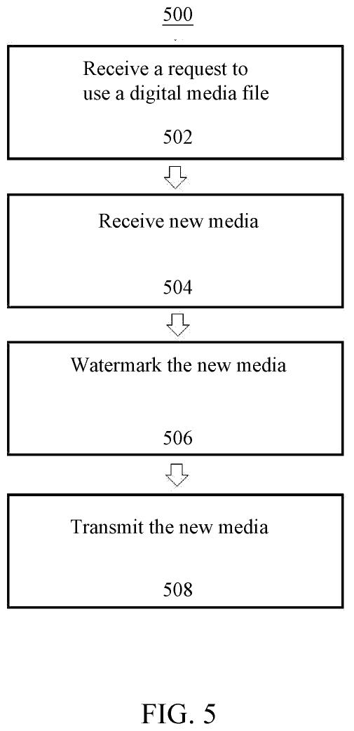

FIG. 5 is a block diagram showing steps of a watermarking method 500, according to an embodiment.

At step 502, the fee distribution system 100 receives a request to use a digital media file. For example, a request is received from an electronic device to use one of the digital media files in the training of a generative artificial intelligence.

At step 504, the fee distribution system 100 receives new media from an electronic device. For example, the request to use one of the digital media files is approved. The electronic device then trains a generative artificial intelligence based on the digital media file. New media generated by the generative artificial intelligence is then transmitted to the fee distribution system 100.

At step 506, the fee distribution system 100 watermarks the new media. For example, the fee distribution system 100 embeds a digital watermark in the new media, where the digital watermark, when extracted, identifies the distribution recipients associated with the digital media file used in training the generative artificial intelligence.

At step 508, the fee distribution system 100 transmits the digitally watermarked new media to the electronic device. For example, the digitally watermarked new media is transmitted back to the electronic device.

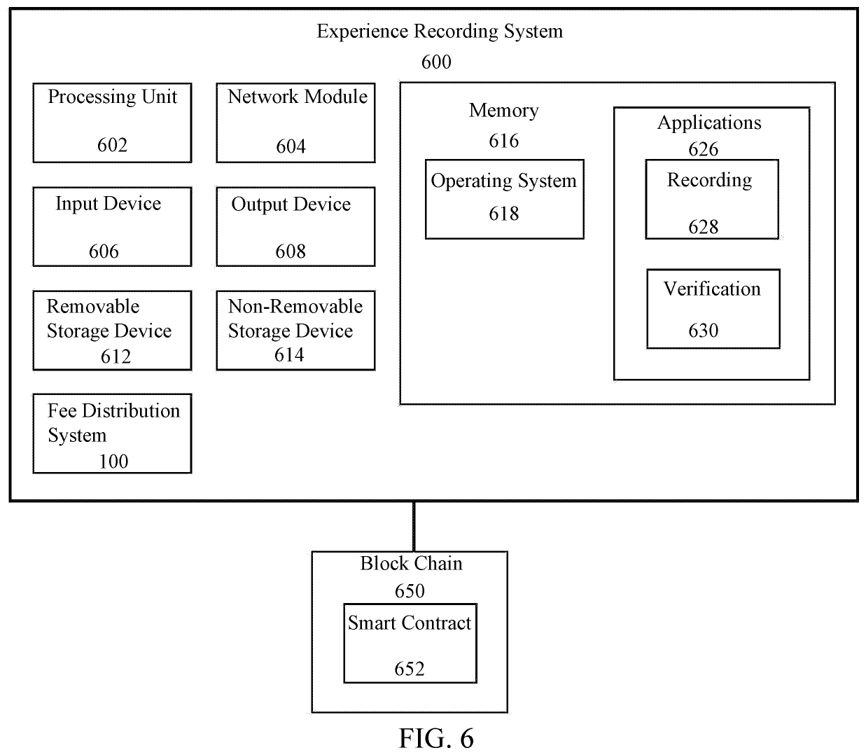

FIG. 6 is a block diagram showing example physical components of an experience recording system 600 configured to record user experiences. In some embodiments, the experience recording system 600 is integrated into, or otherwise part of, the fee distribution system 100. Alternatively, the experience recording system 600 is a standalone system.

Processing unit 602, network module 604, input device 606, output device 608, removable storage device 612, and non-removable storage device 614 may function similarly to processing unit 102, network module 104, input device 106, output device 108, removable storage device 112, and non-removable storage device 114 respectively.

Applications 626 may include a recording application 628 and a verification application 630 as will be further discussed. Accordingly, memory 616 includes all necessary applications 626 per each embodiment.

User experiences are represented as user experience data. User experience data may include a digital media file of any format including, but not limited to, an audio file, image file, or video file. For example, the user experience is a graduation event, and the user experience data includes an image file of an associated diploma. Alternatively, user experience data may include instructions on how to reach a database or webpage containing the aforementioned digital media file. For example, the user experience is a graduation event, and the user experience data includes a uniform resource locater (URL) to a web site displaying an image file of an associated diploma.

The recording application 628 is configured to record the user experience data to a distributed ledger system 650 (also referred to herein as a blockchain network). Exemplary distributed ledger systems may include, but are not limited to, ETHEREUM, BITCOIN, EXODUS, and many others.

In one embodiment, the recording application 618 records the user experience data by transmitting such data via a transaction to a smart contract 652 (“smart contract transaction”) located on the blockchain network 650. The smart contract 652 may follow the Contract Application Binary Interface (“ABI”) for ETHEREUM, or other contract specifications if other blockchain networks are employed. The smart contract 652 preferably enables non-fungible token functionality for the user experience data such that the user experience data cannot be copied, substituted, or subdivided.

The smart contract 652 is associated with location information. In one embodiment, location information comprises a smart contract address deterministically computed from the address of its creator (e.g., the experience recording system 600) and the number of transactions sent by the creator (i.e., nonce). This allows the experience recording system 600 to incorporate the location information into the user experience data and to record the location information with the user experience data via the smart contract 652. Alternatively, a transaction ID may be generated by the blockchain network 650 and stored as proof of the creation of the smart contract 652 in the experience recording system 600 or a user-associated crypto wallet.

In one embodiment, the user experience data includes an address to locate a non-smart contract transaction in a particular block of the blockchain. In another embodiment, the user experience data may be transmitted to a non-smart contract block in a private blockchain network. In yet another embodiment, the user experience data may be stored in a database (i.e., through a database management system of the user device, a local server, a cloud storage system, or a distributed file storage system).

The verification application 630 is configured to verify the contents and/or origin of the user experience data. Preferably, the verification application 630 employs the verification process described in U.S. patent application Ser. No. 18/112,276. Alternatively, other common verification processes may be employed.

The verification application 630 may be further configured to generate verification information. This allows the experience recording system 600 to incorporate the verification information into the user experience data and to record the verification information with the user experience data via the smart contract 652. Verification information may be stored as proof of the contents and/or origin of the experience in the experience recording system 600 or a user-associated crypto wallet.

Verification information may include a digital copy of the certificate. For example, a digital image of the certificate as issued by the certificate authority. Alternatively, verification information may include a digital key and instructions on how to verify the certificate via crosschecking the key with the certificate authority.

In some embodiments, the experience recording system 600 only records user experiences that have been verified via the verification application 630.

Generally, the decentralized architecture provided by blockchain technology, combined with the use of smart contracts, namely those that provide non-fungible token functionality, provides the best solution for recording user experiences. Additionally, vast networks of independent nodes, complex cryptographic communication, and group consensus on ledger updates prevent the possibility of falsifying data on transactions that are public by nature and completely open to users, making data immutable and reliable throughout the network. It will be appreciated that falsification or deletion of blockchain information is prevented, in part, through the implementation of consensus algorithms which oblige independent nodes to agree on past transactions before proceeding to incorporate the transactions in the next proposed block.

Methods in this document are illustrated as blocks in a logical flow graph, which represent sequences of operations that can be implemented in hardware, software, or a combination thereof. In the context of software, the blocks represent computer-executable instructions stored on one or more computer storage media that, when executed by one or more processors, cause the processors to perform the recited operations. Note that the order in which the processes are described is not intended to be construed as a limitation, and any number of the described method blocks can be combined in any order to implement the illustrated method, or alternate methods. Additionally, individual blocks may be deleted from the methods without departing from the spirit and scope of the subject matter described herein.

I claim:

1. A system to distribute fees to a distribution recipient for the use of the distribution recipient's digital media file by a generative artificial intelligence, the system comprising:
memory storing executable instructions;
a processing device executing the instructions, wherein the instructions cause the processing device to:
receive a digital media file, the digital media file including at least one of:
the likeness of a user associated with the distribution recipient;
the likeness of a property associated with the distribution recipient;
receive a share structure for the distribution of a usage fee;
distribute a share of the usage fee to the distribution recipient when a usage event is detected, wherein the share is set by the share structure.

2. The system of claim 1, wherein
the usage event is one of:
the approval of a third-party request to use the digital media file for training a generative artificial intelligence;
the approval of a third-party request to use the digital media file in the creation of media by the generative artificial intelligence;
a third-party generation of media by the generative artificial intelligence, wherein the digital media file is used in the generation of the media by the generative artificial intelligence;
a third-party dissemination of the media, wherein the digital media file is used in the generation of the media by the generative artificial intelligence; and
a third-party monetization of the media, wherein the digital media file is used in the generation of the media by the generative artificial intelligence.

3. The system of claim 1, wherein
the usage event is a third-party monetization of media generated by a generative artificial intelligence, wherein the digital media file is used in the generation of the media by the generative artificial intelligence; and
the usage fee is based, at least in part, on the extent of monetization and the extent of the use of the digital media file in the generation of the media by the generative artificial intelligence.

4. The system of claim 1, wherein
the usage event is a third-party monetization of media generated by a generative artificial intelligence, wherein the digital media file is used in the generation of the media by the generative artificial intelligence; and
the usage fee is based, at least in part, on the extent of monetization and the extent of the use of the digital media file relative to the extent of the use of other digital media files in the generation of the media by the generative artificial intelligence.

5. The system of claim 1, wherein
the usage event is one of:
the approval of a third-party request to use the digital media file for training a generative artificial intelligence;
the approval of a third-party request to use the digital media file in the creation of new media by the generative artificial intelligence;
a third-party generation of media by the generative artificial intelligence, wherein the digital media file is used in the generation of the media by the generative artificial intelligence;
a third-party dissemination of the media, wherein the digital media file is used in the generation of the media by the generative artificial intelligence; and
the usage fee is based, at least in part, on the extent of the use of the digital media file in the usage event.

6. The system of claim 1, wherein the
the usage event is one of:
the approval of a third-party request to use the digital media file for training a generative artificial intelligence;
the approval of a third-party request to use the digital media file in the generation of media by the generative artificial intelligence;
a third-party generation of media by the generative artificial intelligence, wherein the digital media file is used in the generation of the media by the generative artificial intelligence;
a third-party dissemination of the media, wherein the digital media file is used in the generation of the media by the generative artificial intelligence; and
the usage fee is based, at least in part, on the extent of the use of the digital media file relative to the extent of the use of other digital media files in the usage event.

7. The system of claim 1, wherein
the usage event is one of:
the approval of a third-party request to use the digital media file for training a generative artificial intelligence;
the approval of a third-party request to use the digital media file in the generation of media by the generative artificial intelligence; and
the usage fee is preset by the distribution recipients.

8. The system of claim 1, wherein
the instructions cause the processing device to:
transmit a fee table to a third-party device, wherein
the third-party device is in communication with the system;
the fee table includes a plurality of usage fees corresponding to a plurality of digital media files, assisting the third-party with the selection of one of the digital media files to use in:
training a generative artificial intelligence; and
the generation of media by the generative artificial intelligence.

9. The system of claim 8, wherein
the instructions further cause the processing device to:
enable a third-party to filter the plurality of digital media files based on their corresponding usage fees.

10. The system of claim 1, further comprising:
a scanning device configured to perform a 3D scan of one of:
the user associated with the distribution recipient;
the property associated with the distribution recipient;
wherein
the instructions further cause the processing device to:
generate the digital media file based on the scan, the digital media file including at least one of:
the likeness of the user; and
the likeness of the property.

11. The system of claim 1, wherein
the instructions further cause the processing device to:
determine if the digital media file includes at least one of:
the likeness of a user not associated with the distribution recipient; and
the likeness of a property not associated with the distribution recipient;

12. The system of claim 1, wherein
the usage fee is determined when the usage event is detected; and
the usage fee is determined through negotiations between the distribution recipient and a third-party, wherein
the third-party uses the digital media file in at least one of:
the generation of media by the generative artificial intelligence; and
the dissemination of the media, wherein the digital media file is used in the generation of the media by the generative artificial intelligence.

13. The system of claim 1, wherein
the digital media file is received from an electronic device of the distribution recipient, wherein
the electronic device is in communication with the system; and
the electronic device is configured to automatically embed the digital media file with at least one of metadata and a digital watermark, wherein the metadata or the digital watermark, when deciphered, identifies at least one of:
the distribution recipient;
the share structure associated; and
the usage fee.
metadata;
a digital watermark;
wherein metadata in the digital media file when the digital media file is created, the metadata identifying the distribution recipient.

14. The system of claim 1, wherein
the instructions further cause the processing device to:
verify the digital media file by:
receiving an alleged role information for a project related to a service capacity for the distribution recipient from a plurality of sources;
receiving a verification link associated with the alleged role information on the project;
confirming, using a discriminate verification module, the alleged role information;
approving the distribution recipient as a corroborated user for the service capacity on the project;
converting, based on approving the distribution recipient, the unverified project to a verified project;
generating a label for the verified project that is displayed, wherein the label includes a verified project title, the user's verified role in the verified project and at least one public record verification source; and
displaying the label on the distribution recipients' profile.

15. The system of claim 1, wherein
the instructions further cause the processing device to:
enable the distribution recipient to set permissions that require the distribution recipient's approval before the digital media file is used in at least one of:
training a generative artificial intelligence;
the generation of media by the generative artificial intelligence;
publication of the media, wherein the digital media file is used in the generation of the media by the generative artificial intelligence;
a third-party dissemination of the media, wherein the digital media file is used in the generation of the media by the generative artificial intelligence; and
monetization of the media, wherein the digital media file is used in the generation of the media by the generative artificial intelligence.

16. The system of claim 1, wherein
the usage fee is a reoccurring fee based on a lease or subscription model.

17. The system of claim 1, wherein
the usage event is the generation of media by the generative artificial intelligence, wherein the digital media file is used by the generative artificial intelligence in the generation of the media; and
wherein the instructions further cause the processing device to:
transmit watermarking instructions to an electronic device associated with the media, wherein the watermarking instructions, when executed, cause the electronic device to embed the media with a digital watermark that, when extracted, identifies at least one of:
the distribution recipient;
the share structure; and
the usage fee.

18. The system of claim 17, wherein
the instructions further cause the processing device to:
embed the digital media file with a digital watermark that, when extracted, identifies at least one of:
the distribution recipient;
the share structure associated; and
the usage fee.

19. A computer-implemented method for distributing fees to a distribution recipient for the use of the distribution recipient's digital media file by a generative artificial intelligence, the method comprising:
receiving a digital media file, the digital media file including at least one of:
the likeness of a user associated with the distribution recipient;
the likeness of a property associated with the distribution recipient;
receiving a share structure for the distribution of a usage fee;
distributing a share of the usage fee to the distribution recipient when a usage event is detected, wherein the share is set by the share structure.

20. Non-transitory computer storage media storing executable instructions which when executed by a computing device cause the computing device to:
distribute fees for the use of digital media files by a generative artificial intelligence by:
receiving a digital media file, the digital media file including at least one of:
the likeness of a user associated with the distribution recipient;
the likeness of a property associated with the distribution recipient;
receiving a share structure for the distribution of a usage fee;
distributing a share of the usage fee to the distribution recipient when a usage event is detected, wherein the share is set by the share structure.
